(19) United States
(12) Patent Application Publication
(10) Pub. No.: US 2020/0408198 A1
(43) Pub. Date: Dec. 31, 2020

(54) Driving Device, Camera Module and Electronic Apparatus

(71) Applicant: New Shicoh Motor Co., LTD, Zhejiang (CN)

(72) Inventors: Dongming WANG, Zhejiang (CN); Juhe ZHOU, Zhejiang (CN)

(21) Appl. No.: 16/909,168

(22) Filed: Jun. 23, 2020

(30) Foreign Application Priority Data
Jun. 25, 2019 (CN) 201910554720.5

(51) Int. Cl. F03G 7/06

(52) U.S. Cl. CPC F03G 7/065; G02B 7/04

(57) ABSTRACT

A driving device having a base, a carrier, and a driving member is disclosed. The carrier is provided on the base and is movable up and down with respect to the base. The driving member includes a first end fixedly connected to the base and a second end opposite the first end fixedly connected to the carrier. The driving member further includes an intermediate portion between the first end and the second end. The intermediate portion is connected to the carrier and has a height difference in an up-down direction with respect to the first end. The driving member expands and contracts to drive the carrier to move up and down with respect to the base.

### CROSS-REFERENCE TO RELATED APPLICATION

This application claims the benefit of Chinese patent application CN201910554720.5, filed on Jun. 25, 2019, the contents of which are incorporated by reference herein.

### TECHNICAL FIELD

The present disclosure relates to the field of imaging technology, particularly, to a driving device, a camera module, and an electronic apparatus.

### BACKGROUND

As science and technology advance, the application of camera modules has become increasingly widespread, and electronic products such as cameras, mobile phones, and personal computers are now equipped with camera modules. This makes it easy for users to take photos anytime, anywhere, and enhances their everyday convenience and enjoyment. A camera module includes a fixed focus camera module and a focus camera module, in the focus camera module, a lens can be driven and moved to focus by a driving device.

Usually, the driving device includes a base, a carrier and a shape memory alloy (SMA) member. The carrier is movably provided on the base, both ends of the shape memory alloy member are fixed to the base and the intermediate portion thereof is hooked on the carrier. When a current is supplied to the shape memory alloy member, the length the shape memory alloy member is reduced, thus the carrier is pulled to move up and down, and a lens mounted on the carrier is driven so as to move up and down, so that focusing can be realized.

In this driving device, as shown in FIG. 1, when the stroke of the carrier is H, a change in the length of the shape memory alloy member becomes 2×(L1−L2). Here, L1 is the distance from one end of the shape memory alloy member before contraction up to the position on the carrier at which the member is hooked, and L2 is the distance from one end of the shape memory alloy member after contraction up to the position on the carrier at which the member is hooked. Thus, the conversion rate when converting from the contraction amount of the shape memory alloy member into the stroke H of the carrier is low.

Therefore, since the conversion rate from the contraction amount of the shape memory alloy member into the stroke H of the carrier is low, a considerably long shape memory alloy member is required. But, this occupies a large space and adversely affects the miniaturization of the driving device. On the other hand, the longer the contraction of the shape memory alloy member, the shorter the service life, but when the conversion rate from the contraction amount of the shape memory alloy member into the stroke H of the carrier is low, it is necessary to increase the contraction amount of the shape memory alloy member, which adversely affects the service life of the driving device.

It is to be noted that this description is intended only to explain general background information and does not constitute conventional technology.

### SUMMARY

In view of the above, an object of the present disclosure is to provide a driving device, a camera module and an electronic apparatus with large contraction amount and stroke conversion rate.

In accordance with a first aspect of the present disclosure, there is provided a driving device including a base, a carrier and a driving member. The carrier is provided on the base and is movable up and down with respect to the base.

The driving member includes a first end fixedly connected to the base and a second end opposite the first end fixedly connected to the carrier. The driving member further includes an intermediate portion between the first end and the second end. The intermediate portion is connected to the carrier, and has a height difference in an up-down direction with respect to the first end. The driving member expands and contracts to drive the carrier to move up and down with respect to the base.

In accordance with a second aspect of the present disclosure, there is provided a camera module including the driving device described above.

Furthermore, in accordance with a third aspect of the present disclosure, there is provided an electronic apparatus including the camera module described above.

### DESCRIPTION OF DRAWINGS

FIG. 1 is a diagram showing a contraction state of a shape memory alloy wire in a driving device of a related art;

FIG. 2 is a perspective view of an assembly configuration of a driving device according to an embodiment of the present disclosure;

FIG. 3 is an exploded configuration diagram of the driving device shown in FIG. 2 viewed from one direction;

FIG. 4 is an exploded configuration diagram of the driving device shown in FIG. 2 viewed from another direction;

FIG. 5 is a configuration diagram showing a state in which a housing is removed from the driving device shown in FIG. 2;

FIG. 6 is a cross-sectional configuration diagram of the driving device shown in FIG. 2;

FIG. 7 is a diagram showing a contraction state of a driving member in the driving device shown in FIG. 2;

FIG. 8 is an explanatory drawing of the contraction principle of the shape memory alloy wire in the driving device shown in FIG. 1; and

FIG. 9 is an explanatory drawing of the contraction principle of the driving member in the driving device shown in FIG. 2.

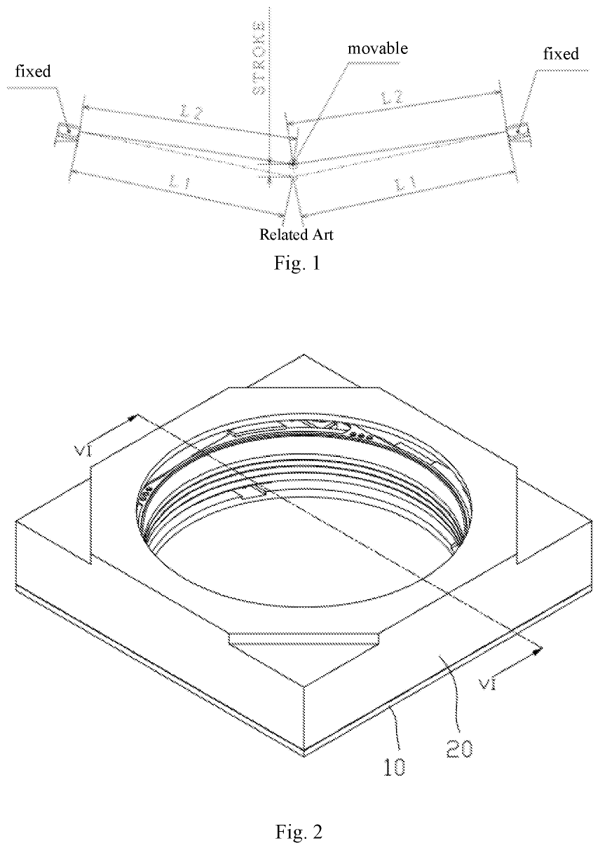

### DETAILED DESCRIPTION

Hereinafter, embodiments of the present disclosure will be explained in more detail with reference to the accompanying drawings. The following embodiments are for explaining the present disclosure and are not intended to limit the present disclosure.

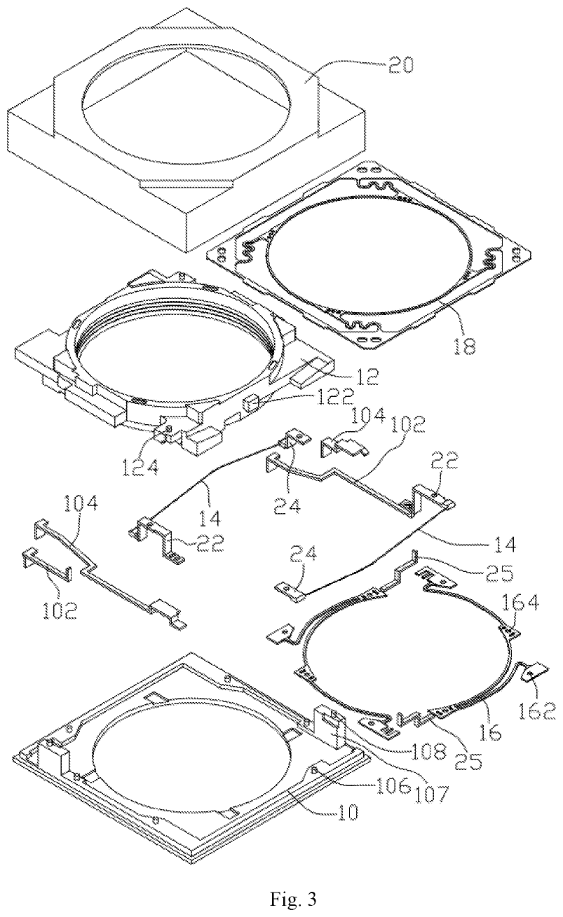

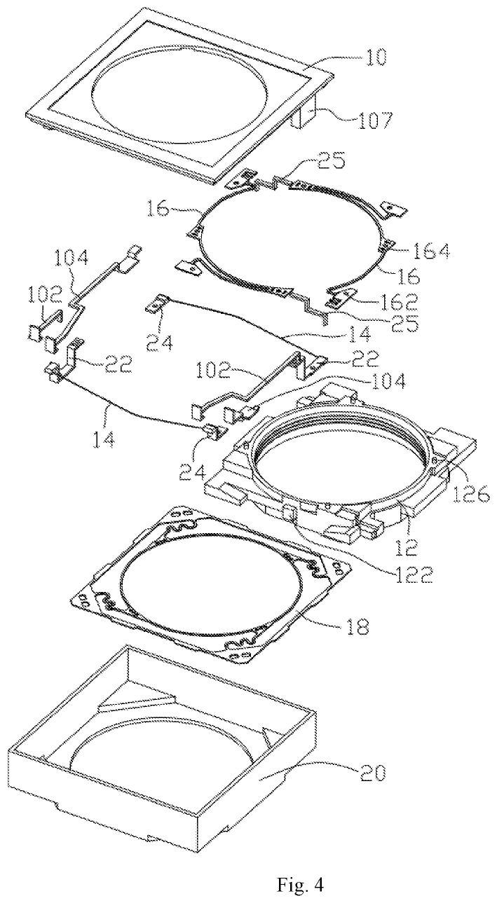

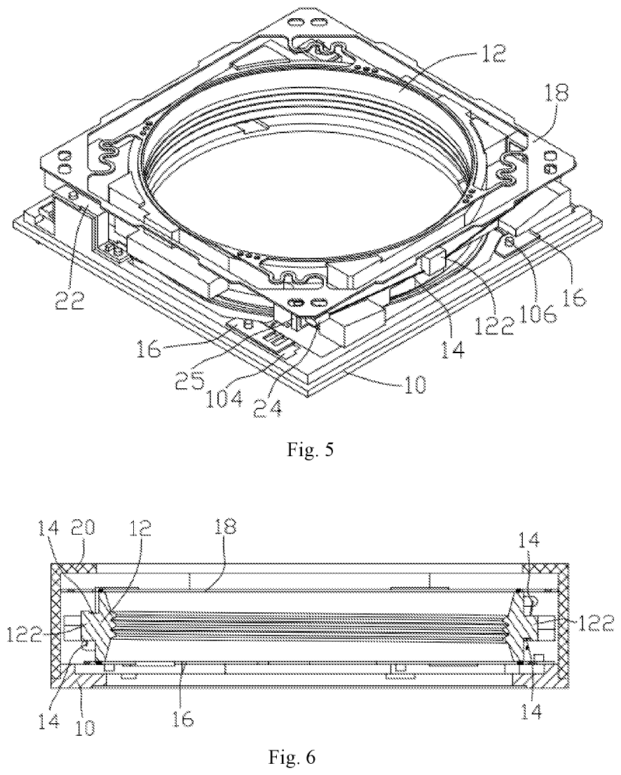

As shown in FIG. 2 to FIG. 6, a driving device according one embodiment of the present disclosure includes a base 10, a carrier 12, a driving member 14, a lower spring 16, an upper spring 18 and a housing 20. The carrier 12 is provided on the base 10 so as to be movable up and down with respect to the base 10. The driving member 14 has a first end fixedly connected to the base 10 and a second end opposite the first end fixedly connected to the carrier 12. An intermediate portion between the first end and the second end of the driving member 14 is connected to the carrier 12. The driving member 14 expands and contracts to drive the carrier 12 to move up and down with respect to the base 10. Specifically, the intermediate portion forms a difference in height in the up-down direction with respect to the first end.

Further, the lower spring 16 is elastically provided between the base 10 and the carrier 12, and the upper spring 18 is elastically provided between the carrier 12 and the housing 20. The housing 20 is provided above the carrier 12 and is covered so as to contain the base 10, the carrier 12, the driving member 14, the lower spring 16 and the upper spring 18 inside. The housing 20 is further fixedly connected to the base 10.

In the present embodiment, the base 10 includes a first terminal 102 and a second terminal 104. The first terminal 102 and the second terminal 104 are made of conductive material and separated from each other. The first terminal 102 and the second terminal 104 can be fitted to the base 10 by an insert-molding method. Specifically, the base 10 is provided with a first protruding column 106. The base 10 is further provided with a protruding block 107. The protruding block 107 is provided with a second protruding column 108. In the present embodiment, the first terminal 102 and the second terminal 104 are connected to an external power source, and two first terminals 102 and two second terminals 104 are provided.

In the present embodiment, the carrier 12 is provided with a hooking block 122, a third protruding column 124 and a fourth protruding column 126. Specifically, two hooking blocks 122 are provided and respectively protrude outward from central portions of two outer side surfaces of the carrier 12 which face to each other. The fourth protruding column 126 is provided at the bottom portion of the carrier 12. The carrier 12 is used to mount a lens (not shown) in a central through hole, and drives the lens to move up and down so as to achieve focusing.

In the present embodiment, the driving member 14 is a shape memory alloy wire. Specifically, in the present embodiment, two driving members 14 are provided. The intermediate portion of the driving member 14 is hooked on the hooking block 122 of the carrier 12. Specifically, the intermediate portion of one driving member 14 is hooked on the bottom portion of the hooking block 122 and provides an upward force to the carrier 12 when contracting. Specifically, the intermediate portion of the driving member 14 is located below the first end and the entire driving member 14 is in a downward curved shape. The intermediate portion end of the other driving member 14 is hooked on the top portion of the hooking block 122 and provides a downward force to the carrier 12 when contracting. Specifically, the intermediate portion of this driving member 14 is located above the first end and the entire driving member 14 is in an upward curved shape.

In this way, when one driving member 14 moves the carrier 12 upwards when contracting and the other driving member 14 moves the carrier 12 downwards when contracting. Further, the driving member 14 maintains the above-mentioned curved shape even during movement. Specifically, two driving members 14 are respectively provided on outer edges on two opposite sides of the carrier 12.

Of course, there may be only one driving member 14. In this case, the driving member 14 needs to be restored after the movement by using the force of the lower spring 16 and the upper spring 18. It is to be noted that, the intermediate portion of the driving member 14 may be fixed to the carrier 12.

In the present embodiment, the driving device further includes a first wire holding terminal 22 and a second wire holding terminal 24. The first wire holding terminal 22 and the second wire holding terminal 24 respectively hold and fix the first end and the second end of the driving member 14. The first wire holding terminal 22 is connected to the first terminal 102 and electrically connected to the first terminal 102. The second wire holding terminal 24 is electrically connected to lower spring 16. The lower spring 16 is electrically connected to the second terminal 104. The second wire holding terminal 24 is fixedly connected to the carrier 12. Thereby, the driving member 14 is electrically connected to the first terminal 102 and the second terminal 104, and a current can be supplied to the driving member 14. The shape memory alloy wire contracts when the current is supplied, which realizes the expansion and contraction of the shape memory alloy wire. At the same time, the first end of the driving member 14 is fixedly connected to the base 10 and the second end is fixedly connected to the carrier 12.

Specifically, the second wire holding terminal 24 is electrically connected to the lower spring 16 via a connection member 25. The first wire holding terminal 22 is provided with a first fixing hole and a second fixing hole. One end of the first terminal 102 is inserted into the first fixing hole and the second protruding column 108 is inserted into the second fixing hole. The second wire holding terminal 24 is provided with a third fixing hole and the third protruding column 124 is inserted into the third fixing hole.

Specifically, in the present embodiment, two groups of first wire holding terminals 22 and second wire holding terminals 24 are provided to respectively hold the driving members 14, and two lower springs 16 are provided correspondingly. Since two driving members 14 are connected to the first wire holding terminals 22 and the second wire holding terminals 24 in the same manner, it will not be described again here.

Specifically, each of the lower springs 16 includes a first portion, a second portion and a lower elastic deformation portion. The first portion is provided with a first connection hole 162, and the first protruding column 106 of the base 10 is inserted into the first connection hole 162 so that the first portion of the lower spring 16 is fixedly connected to the base 10. The second portion is provided with a second connection hole 164, and the fourth protruding column 126 of the carrier 12 is inserted into the second connection hole 164 so that the second portion of the lower spring 16 is fixedly connected to the carrier 12. The elastic deformation portion elastically connects the first portion and the second portion.

In the present embodiment, the upper spring 18 includes a third portion, a fourth portion and an upper elastic deformation portion. The third portion is fixedly connected to the carrier 12, the fourth portion is fixedly connected to the housing 20, and the upper elastic deformation portion elastically connects the third portion and the fourth portion so as to elastically connect the carrier 12 and the housing 20.

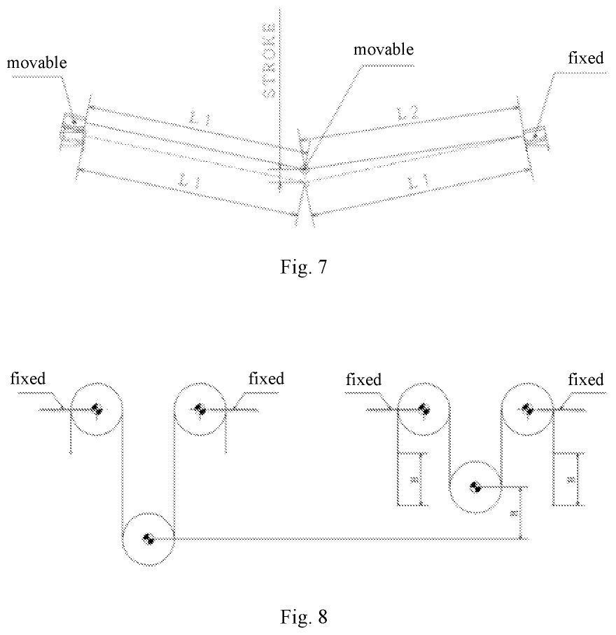

In the driving device of the present embodiment, the first end of the driving member 14 is fixed to the base 10, and the second end can move together with the carrier 12. As shown in FIG. 7, when the stroke of the carrier 12 is H, the length change of the driving member 14 is (L1−L2). Here, L1 is the distance from the first end of driving member 14 before contraction up to the position where the intermediate portion is connected to the carrier 12, and L2 is the distance from the first end of the driving member 14 after contraction to the position where the intermediate portion is connected to the carrier 12. Compared with the conventional driving device, the length change of the driving member 14 is reduced by half while the carrier moves the same stroke, therefore in the driving device according to the present embodiment, when the contraction amount of the driving member 14 is converted into the stroke of the carrier, the conversion rate increases.

Therefore, since the conversion rate in converting the contraction amount of the driving member 14 into the stroke of the carrier is high, the required length of the driving member 14 is short, which reduces the occupied space and is advantageous in the miniaturization of the driving device. Further, since the contraction amount of the driving member 14 is small, the service life thereof is extended, which is advantageous in extending the service life of the driving device.

As shown in FIG. 8, there is shown a diagram for explaining the principle of the contraction amount of the shape memory alloy wire when the upward movement amount of the carrier 12 in the conventional driving device is set to height H. When the upward movement amount of the intermediate portion (the portion connected to the carrier) of the shape memory alloy wire is height H, the left and right sides of the shape memory alloy wire respectively contract by H, and the total contraction amount becomes 2H.

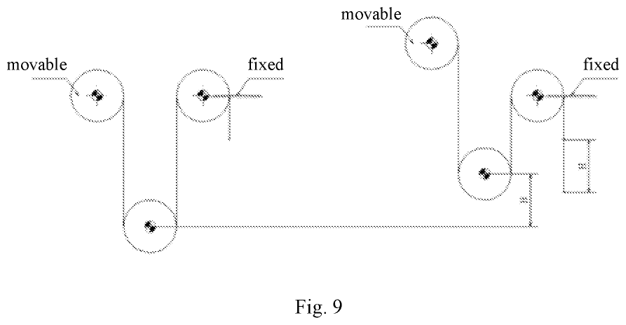

As shown in FIG. 9, there is shown a diagram for explaining the principle of the contraction amount of the shape memory alloy wire when the upward movement amount of the carrier 12 in the driving device according to the embodiment of the present disclosure is set to height H. When the upward movement amount of the intermediate portion (the portion connected to the carrier) of the shape memory alloy wire is height H, an upward movement of height H also occurs on the left side of the shape memory alloy wire. That is, no contraction occurs on the left side of the shape memory alloy wire. Then, the right side of the shape memory alloy wire contracts by H, and the total contraction amount becomes H. In this way, in the driving device according to the present embodiment, the conversion rate of the contraction amount of the driving member 14 to the stroke of the carrier increases.

In the present embodiment, a guide rail (not shown) may be provided on either of the base 10 and the carrier 12, and a guide groove that fits the guide rail may be provided on the other. Since the second end and the intermediate portion of the driving member 14 are movable and the other end is fixed, the driving member 14 generates a force onto the carrier 12, which forms a predetermined included angle with the vertical direction, and the carrier 12 is rotated by this force. But by providing the guide rail and the guide groove, it is possible to avoid rotation of the carrier 12 with respect to the base 10. Of course, the guide rail and the guide groove may be provided in the housing 20 instead of the base 10. Further, the carrier 12 may be provided with a stopper for preventing rotation.

Further, as an embodiment of the present disclosure, a camera module including the above-mentioned driving device is provided.

Further, as another embodiment of the present disclosure, an electronic apparatus including the above-mentioned camera module is provided.

In the drawings, the size and relative size of each layer and region are enlarged to be larger than the actual size in order to make the configuration in the drawings easier to see. In this specification, the description that a member such as a layer, a region, or a substrate “forms/is formed”, “provides/is provided”, or “locates/is located” on another member means that the corresponding configuration is directly provided on another configuration, or an intermediate configuration is used. On the other hand, when it is described as “directly form/formed” or “directly provide/provided” on another member, it means that the intermediate configuration is not used.

In this specification, unless otherwise specified or limited, the terms “attach”, “connect to each other” and “connect” may be understood in a generalized meaning. For example, fixed connection, removable connection, integral connection, mechanical connection, electrical connection, direct connection, connection with intermediate configuration, connection with internal communication of two configurations and the like are included. Those skilled in the art can understand the meaning of the above terms specifically.

It should be noted that in the present specification, the direction or positional relationships represented by terms such as “up”, “down”, “front”, “rear”, “left”, “right”, “top”, “bottom”, “inner”, “outer”, “vertical” and “horizontal” and the like are direction or positional relationships based on the drawings for clarifying technical means of the present disclosure and for convenience of explanation, and are not expressions limiting the present disclosure.

In the present specification, terms such as “first” and “second” indicating the order of configuration are simply for distinguishing between similar structures, and it does not mean that the relevant configuration has to obey a fixed order, time, space, level or other restrictions.

In the present specification, the expressions “plurality” and “several” refer to two or more than two, unless otherwise specified.

Further, the technical features described in the embodiments of the present disclosure can be arbitrarily combined, and in order to simplify the description, all possible combinations of the technical features in the above-described embodiments are not described herein. However, unless there is a contradiction in the combination of these technical features, all should be understood as the scope described in the present specification.

As used herein, “comprising”, “including” or any other variations thereof are intended to include non-exclusive inclusions, and may include other unexplained configurations other than the listed configurations.

Although the specific embodiments of the present disclosure have been described above, the protection scope of the present disclosure is not limited thereto. A person skilled in the art can easily perform a modification or substitution within the technical scope disclosed by the present disclosure, and all should be included in the protection scope of the present disclosure. Therefore, the protection scope of the present disclosure should be in accordance with the claims. What is claimed is:

1. A driving device comprising:
a base;
a carrier; and
a driving member,
wherein the carrier is disposed on the base and is movable up and down with respect to the base,
the driving member comprises a first end, a second end opposite the first end, and an intermediate portion between the first end and the second end,
the first end is fixedly connected to the base,
the second end is fixedly connected to the carrier,
the intermediate portion is connected to the carrier, with a height difference in an up-down direction with respect to the first end, and
the driving member is expanded and contracted to drive the carrier to move up and down with respect to the base.

2. The driving device according to claim 1, wherein the driving member is a shape memory alloy wire.

3. The driving device according to claim 1, wherein:
the base comprises a first terminal and a second terminal,
the first terminal and the second terminal are separated from each other, and
the first end of the driving member is fixedly connected to the first terminal.

4. The driving device according to claim 3, further comprising a first wire holding terminal and a second wire holding terminal, wherein:
the first wire holding terminal and the second wire holding terminal hold and fix the first end and the second end of the driving member, respectively,
the first wire holding terminal is connected to the first terminal, and
the second wire holding terminal is fixedly connected to the carrier.

5. The driving device according to claim 4, further comprising a lower spring, wherein:
the first terminal and the second terminal are made from conductive material,
the first wire holding terminal is electrically connected to the first terminal,
the second wire holding terminal is electrically connected to the lower spring, and
the lower spring is electrically connected to the second terminal.

6. The driving device according to claim 1, wherein:
the carrier comprises two hooking blocks,
two driving members are provided,
the intermediate portion of one of the driving members is hooked on a bottom portion of one of the hooking blocks to provide an upward force to the carrier, and
the intermediate portion of the other one of the driving members is hooked on a top portion of the other one of the hooking blocks to provide a downward force to the carrier.

7. The driving device according to claim 6, wherein the two driving members are respectively provided on outer edges on opposite sides of the carrier.

8. The driving device according to claim 1, further comprising an upper spring and a housing, wherein:
the upper spring is elastically provided between the carrier and the housing, and
the housing is provided above the carrier and is covered so as to contain the base, the carrier, the driving member and the upper spring inside.

9. A camera module comprising the driving device according to claim 1.

10. An electronic apparatus comprising the camera module according to claim 9.
